(19) United States
(12) Patent Application Publication
(10) Pub. No.: US 2007/0171420 A1
(43) Pub. Date: Jul. 26, 2007

(54) PULSED ELLIPSOMETER DEVICE

(75) Inventor: Frederic Ferrieu, Meylan (FR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics SA, Montrouge (FR)

(21) Appl. No.: 11/614,673

(22) Filed: Dec. 21, 2006

(30) Foreign Application Priority Data
Dec. 22, 2005 (FR) 0554036

(51) Int. Cl. G01J 4/00

(52) U.S. Cl. 356/369

(57) ABSTRACT

An ellipsometry device includes a first pulsed source, and optical elements for generating polarization and/or phase and detection of polarization or analysis. A signal detector detects the generated pulses. A controller is coupled to the signal detector for generating feedback pulses or control pulses to the optical elements. The controller is also coupled to the signal detector.

### FIELD OF THE INVENTION

The invention relates to measurement techniques for characterizing materials, and more particularly, to characterizing the nature of the material or the thickness of the layers, notably ultra thin layers.

### BACKGROUND OF THE INVENTION

The ability to produce very fine layers leads to a need for new methods for enabling the materials to be characterized. There is also a need for measurement techniques having extremely fast measurement rates. This is applicable to the metrology of dielectrics of grids of materials of the “high k” type, and to the real time measurements of growth or modification in materials used in nanotechnology.

### SUMMARY OF THE INVENTION

The invention is directed to an ellipsometry device comprising a first pulsed source, optical elements to generate polarization and/or phase and to detect polarization or to analyze it, and signal detection means. There is also means to generate synchronous mode feedback or control digital mode pulses for at least two of the optical elements, for example position, or one optical property of at least two of these elements, plus control pulses for detection means.

Among these optical elements, certain of them are arranged upstream in relation to the direction of the pulses, and others downstream in relation to the direction of a sample or the emplacement for a sample. Likewise, the means to generate feedback pulses (synchronous mode) or control pulses (digital mode) for at least two of the optical elements permit closed loop control or control of at least one optical element upstream and one optical element downstream of the emplacement or sample.

The radiating source may be the modulation reference, and may be used as the clock in the measurement system. A series of cadenced light pulses may thus be used. The pulses have, for example, a width on the order of several picoseconds (as with certain pulsed lasers) or on the order of milliseconds (as with Flash or Xenon lamps).

This series of pulses may serve as a sequential time base for the control of modulation elements, for example, through the rotation of an optical element such as a polarizer, an MgF₂ bimetallic or bilayer element, or a photoelastic modulator and means of detection.

The clock is stopped or started by a cue or starting signal from the measurement instrument, for example, supplied by the operator or some other arrangement. It thus permits generation of the mechanism controlling the regulation of the rotation of an optical element, such as a polarizer and a polarization analyzer, with or without a compensator blade or photoelectric modulator. These rotations may be carried out at high speed by controlling a stepping motor.

When an external arrangement generates another signal, for example, an exciter signal on the sample coming from a second source, delayed control means allow delay in triggering the source to be varied and thus the means for generating the control pulses. It is therefore possible to adjust the delay in relation to the external excitatory source triggering means. This provides the possibility of carrying out time resolved spectroscopic measurements (TRS). For example, it is possible to measure a transitory effect on a modified index via an external excitation.

Another aspect of the invention is directed to a procedure for ellipsometric measurement of the surface state and/or nature of the sample, comprising the emission of radiated pulses from a first radiating source, and servo or control pulses of at least two optical elements of polarization modulation and/or phase and/or polarization analysis, while generating control pulses for the means of detection. The sample may have been previously irradiated by a beam from a second radiating source, and in which case the means of detection can detect a signal offset in relation to the instant of irradiation by the second source. The control pulses of the means of detection open a reading window that is limited in time.

Among the optical elements, certain are disposed upstream of the sample in relation to the direction of propagation of the radiating pulses, and others are downstream of the sample. The feedback pulses (synchronous mode) or control pulses (digital mode) of at least two optical elements permit the interlocking or control of at least one optical element upstream and at least one optical element downstream of the said sample.

There are numerous advantages of the ellipsometry device, particularly proper matching with Xenon flash sources that benefit from excellent brilliance and high punctuality. The ellipsometry device is equally compatible with a wide spectral band, easily adapted, for example, by modifying the current supplied to the source or by changing the nature of the source's envelope.

A pulsed VUV source (spectral range of 10 eV to 110 eV) may also be used. This thus opens up a new spectral band. Furthermore, the ellipsometry device permits utilization of 100% of the source's light period.

The procedure and the arrangements according to the ellipsometry device are particularly suited to lithography which employs photosensitive materials, or to an organic milieu (in the nanotechnology domain) since the duration of the illumination may be extremely short depending on the source selected.

The ellipsometry device has applications in the metrology of ultra thin layers and the examination of defects, with the use of pulsed sources (e.g., in the energy ranges from 10 eV to 40 eV). The ellipsometry device is also applicable to unequalled measurement speeds in domains as varied as metrology of “high k” type dielectric grids and the real time measurement of growth or modification of materials employed in nanotechnology.

### BRIEF DESCRIPTION OF THE DRAWINGS

FIGS. 1A and 1B represent two ellipsometric devices according to the invention.

FIG. 2 is a diagram of the operation of a pulsed source ellipsometer according to the invention.

FIG. 3 represents a pulse triggering a flash lamp and the pulse emitted by the lamp according to the invention.

FIG. 4 is a diagram of the operation of a classical ellipsometer with a continuous source.

FIGS. 5A and 5B represent other ellipsometric arrangements according to the invention.

FIG. 6 represents a sample index variation curve after excitation by a second source according to the invention.

FIG. 7 represents a variation curve of the intensity detected after excitation of the sample by the source, and a time based detection window.

### DETAILED DESCRIPTION OF THE PREFERRED EMBODIMENTS

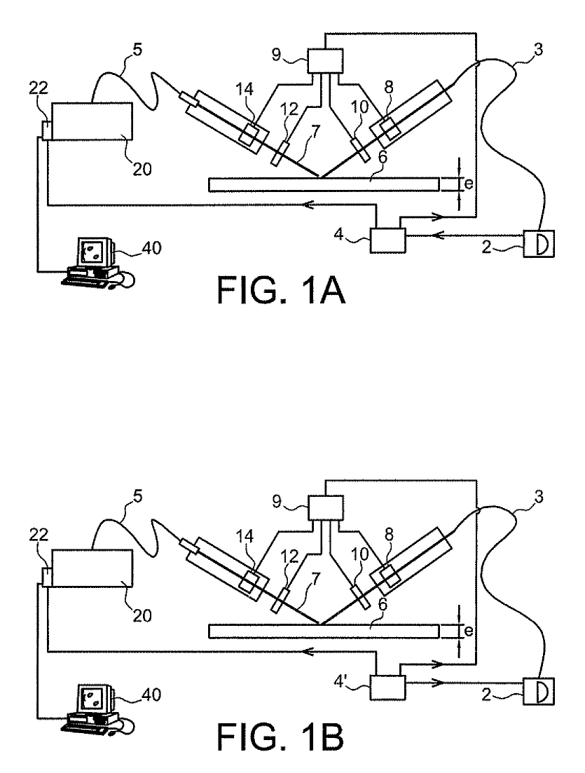

The ellipsometry device implements techniques of ellipsometric measurement, but employs a pulsed radiating source. First and second examples of the invention are illustrated in FIGS. 1A and 1B.

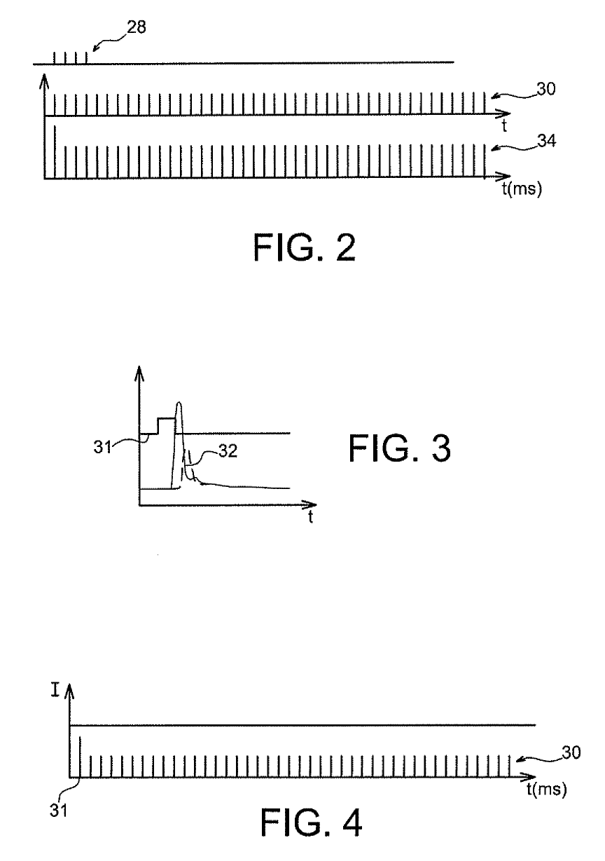

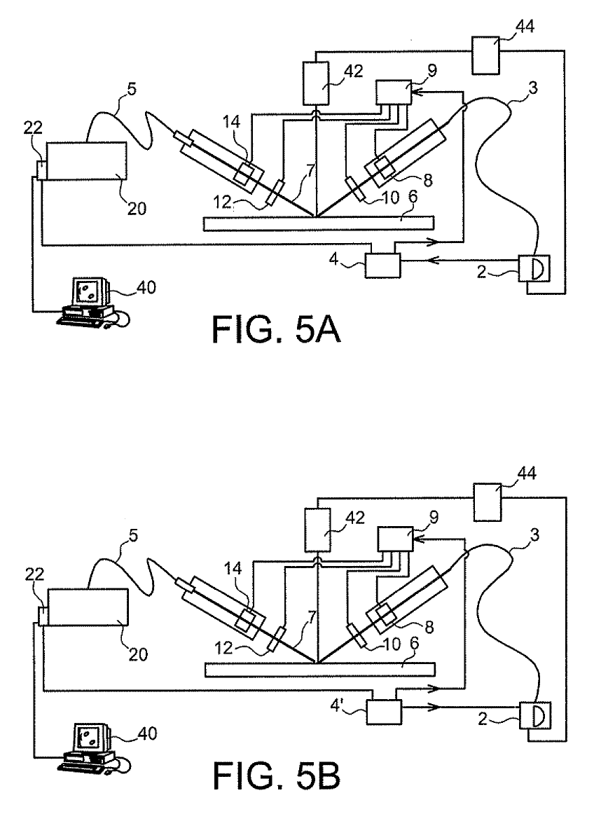

In FIG. 1A, a pulsed radiating source 2 is triggered and delivers pulses, for example in the form of pulses 30 as shown in FIG. 2. This radiating source may be triggered by a triggering means not shown in FIG. 1A, and delivers triggering pulses such as 28 shown in FIG. 2. The triggering pulses may, for example, be initiated by a second source of excitation 42 as shown in FIGS. 5A and 5B.

The pulses from the source 2 are dispatched to electronic means 4, which permit the control of multiplexers 9 and control of the means of detection, in this case a detector 22 (e.g., a photomultiplier) that may be coupled with a monochromator 20 or a spectrograph coupled with a CCD strip. Thus, the pulses from the source 2 will allow control both of the cadence of the operation of the optical elements and the cadence of acquisition of data (or sampling comb).

In FIG. 1B, the means 4′ comprise a reference clock that selects the time intervals and positions the optical analysis and polarization elements. It then triggers the flash or light pulse from the pulsed radiating source 2. In other words, it is when optical elements 8, 10, 12, 14, via the intermediary of the multiplexer 9 reach a predetermined position (e.g., a certain angle for a polarizer) that the light pulse is triggered.

In the example in FIGS. 1A and 1B, the optical means comprise, upstream of a sample 6, a first means of generating polarization 8 and/or phase 10. The multiplexer means 9 control at least one of the optical elements 8, 10 of the arrangement.

After reflection, or more generally, after interaction with the sample 6, upstream of the latter and by following the trajectory of propagation of the light pulse, an output beam 7 passes successively through the polarization analysis means: a second (phase) compensator blade 12 and/or a second polarizer 14. The multiplexers 9 control at least one of the optical elements 12, 14 of the arrangement. This beam can then be processed by the monochromator 20 (PM) or the spectrograph CCD, and is then detected by the detection means 22,

The optical fibers 3, 5 allow the light to be conducted from the source to the optical means and from the latter to the monochromator/detector ensemble. In the case of a VUV source, collimation means are used employing UV treated mirrors.

The ellipsometry device thus permits the carrying out of a control assembly controlling an ellipsometer modulation element, for example, a turning polarizer (generation of polarization) with a fixed analyzer (detection of polarization). One may also have a turning analyzer and a fixed polarizer. The signal coming from the multiplexer means 9 may equally permit the control of a Kerr effect (piezoelectric) photoelastic cell 10, 12 (magneto-optical).

A series of cadenced light pulses, for example, pulse widths on the order of 1 μs to 10 μs or on the order of ms between 1 ms and 5 ms, for example, as is the case with Xenon flashes, may be used as a sequential time base. Or, (as in FIG. 1B), a clock may control the positions of the optical elements and the triggering of the light pulses. Thus, the trigger of a source itself 2 can be used, after electronic formatting in order to control the modulation elements as explained above.

The clock (for example, the reference coder of modulation, polarization or phase) can be stopped or started by a cue or starting signal of a measurement instrument synchronization that the observer introduces.

This starting triggering signal can be given, for TRS type applications, by the pulse of an initial excitation (supplied by means 42 in FIGS. 5A, 5B) and directed at the sample, for example, a first laser directed at the surface of the sample. In this case, it is possible to adjust the delay means 44 between this first excitation and the triggering synchronization signal of source 2 pulses in order to carry out transitory measurements. The first excitation of the surface is translated into a transitory modification of the sample material index 6. This will be translated into a modification of the ellipsometric signal, obtained by reflecting the signal of source 2 on the sample surface 6. This is in relation to the time difference in the triggering of the two sources, a difference which as explained above may be variable.

Due to the control by an electric trigger, the latter may be variably delayed in order to measure a transitory effect index modified by an external excitation that then triggers the measurement. Time resolved spectroscopic index measurements may be thus carried out. This aspect may be defined in general terminology as optical digital addressing. The light pulse can then be synchronized with a predetermined angular position in time of an optical modulation element in order to measure the response in light intensity of the material, and this simultaneously over an entire wide spectral range.

The acquisition and data processing means 40 of the microprocessor or microcomputer type, may be coupled with detector 22. The light source cadences the frequency of the measurement clock in a synchronous manner.

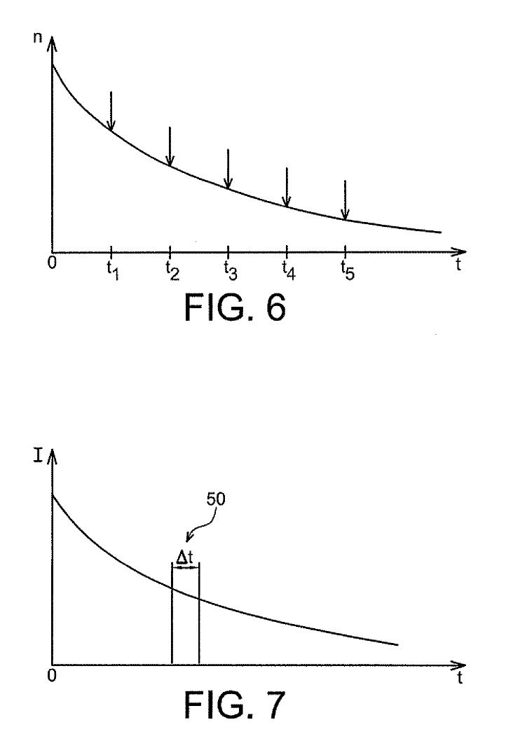

In the cases shown in FIGS. 5A, 5B the triggering of the acquisition correlates it to the emission of pulses from the source 2, itself variable in relation to the triggering of the means 42. This allows acquisition of data at a variable instant in relation to the instant these means 42 to deliver the light pulses to the surface of the sample. This is illustrated in FIG. 6, which represents an example of a variation curve, in relation to time t, of index n of the surface of the material 6 previously irradiated (at instant 0) by the source 42, and at different instants t₁, t₂, t₃, t₄, t₅ after irradiation. The different instants are defined by the variable delay imposed by means 44, at which the surface of the sample may be probed by the ellipsometric measurement.

The source 2 of pulses is, for example a Xenon flash or a laser operating in pulsed mode. One can also utilize a harmonic generation laser, such as a laser doubled or tripled in frequency. One can also use a mixture of a laser base frequency and one or more harmonics to obtain a pulse whose spectrum is of the white light type. Capillary discharge tubes may also be used, allowing generation of pulses in the ultra violet in a vacuum. The optical components are adapted according to the spectral range.

For a Xenon flash lamp, FIG. 3 represents the trigger current pulse 31 responsible for ionization of the Xenon gas in the lamp which generates the flash 32. This mode of operation is, for example, that of Hamamatsu Xenon lamps.

FIG. 2 is a diagram of pulsed ellipsometry in the case where a flash 2 contains an internal clock. This latter supplies the trigger, or the pulse trigger, which permits:

a) the triggering of each flash (pulse 30);

b) the synchronizing of the modulation of the optical means, for example 8, 10, 12, 14 and means 22 or sampling comb (pulses 34); and

c) measuring reflectivity for a given position of the polarization modulation element 8.

The ellipsometry device also applies to a metrology system of the ellipsometric type having turning compensatory blades, with implementation of Mueller matrices. For example, see the following articles: R. W. Collins, J.O.S.A 16, 8, 1997 (1999); R. W. Collins et al. “Advances in multichannel spectroscopic ellipsometry”, Thin Solid Films, 313-314, 18-32 (1998) and which are based on the operating modes described by J. Opsal et al. “Broadband spectral operation of a rotating compensator ellipsometer”, Thin Solid Films, 313-314, 68-61 (1998); Y. Talmi et al. “Self scanned photodiode array: a multichannel spectrometric detector”, Appl. Opt. 19, 1401-1414 (1980).

Starting from a clock signal or a source pulse, it is possible to control the regulation of the rotation of the polarizer and/or one or several compensator blades, for example, by the movement of a stepping motor in relation to the time scale.

Clock frequencies on the order of 300 Hz to 500 Hz are suited to mechanical rotation with a frequency on the order of 50 Hz to 100 Hz. One then counts several synchronization signals generated by the source clock.

One may also use higher frequencies, for example, for cells of the photoelastic modulator type. This clock frequency may also be used to cadence a data acquisition board of means 22.

An integration function is possible, by grouping several channels. The clock frequency can also be used as an incremental base for the positioning of the synchronous analyzer with the measurement (end of travel).

One can thus produce a pulsed ellipsometer with, for example, a turning polarizer or turning analyzer or turning compensator blade. A frequency equal to an entire multiple of this same clock frequency can also be used to produce synchronous assembly of additional turning compensator blades, by employing Mueller matrices, as previously mentioned.

The ellipsometry device also permits implementation of two measurement modes. The first mode (FIGS. 1A, 5A) called the synchronous mode, is applicable to rotations or mechanical frequencies. The pulsed light from source 2 is the synchronous base frequency of the rotations and means of detection 22.

In the second mode, known as digital optical addressing (FIGS. 1B, 5B), a reference clock selects time intervals and positions the optical analysis and polarization elements, then triggers the pulsed light flash of the source. One interest of this is to select a minimum number of polarization states to measure Stokes vectors after reflection on the sample. This mode of operation is furthermore shorter from the time point of view.

In one example of realization, a motor that supports for example a polarizer, is to be turned with incremental angular steps triggered by the flash from the lamp 2.

The source is an FLX type (xenon flash), of very small size. It may be considered as a minute light source (on the order of 1 mm in diameter). It can be cadenced in frequency according to the choice of the user. The maximum working frequencies are on the order of 300 Hz to 500 Hz for a power of approximately 40 to 60 Watts. This frequency is limited by the signal reading time on the photo detector (or the CCD strips). Their spectral range depends on the choice of the envelope. For an MgF₂ envelope the same spectral range as a tungsten source W or as adeuterium D2 source is obtained.

According to one mode of operation, the first signal or light flash, cadences one rotation period of a high speed stepping micro motor, for example, with a hollow axis turning the polarizer (internal axis 10 mm), designed to turn at a frequency equal to a whole number of pulses generated at the frequency of the FLX light source. This is due to its internal coder operating in a phase servo loop.

The means of detection 22 may comprise a photomultiplier (that operates as a photon counter) or a photodiode strip, for example, of the PXUV type (Deep well silicon photodiode in a spectrograph with a 16 or 24-bit converter).

The monochromator 20 may also be a mini-monochromator. Such an arrangement 20 may be coupled, with or without fiber optics. This is the case of the Hamamtsu C9404-5 mini transmission network and the Oriel Cornerstone; such devices are equally available from Horiba J Y.

For signal processing, a compact solution is a type C3866 discriminator with a Hamamtsu C3830 type supply. One can then thus drive a cooled photomultiplier 22, in the visible range, mounted on a mini monochromator 20.

The processing electronics can use two channels with more than 32000 points of acquisition at more than 20 MHz, for example, in the case of an MCA8000A acquisition board from FastComtec. The board sizes may be pocket format. Such a board can make acquisitions on two channels simultaneously with de-phasing between them, and with TTL frequencies on the order of 231 c/s per channel at 20 MHz.

The ensemble has a reduced size and can easily be controlled by a computer 40, even a portable computer, via USB links. Contrary to all known devices, the ellipsometry device uses a pulsed source. It is thus an optical measurement technique in which the light source of the ellipsometer is stopped to pre-select a predefined polarization status. The source is then pulsed.

The ellipsometry device also permits the use of high energies (e.g., pulsed sources emitting around 10 eV to 40 eV) and time resolved spectroscopy (TRS).

One example of application is the time based addressing of polarization or phase selection on components. As illustrated in FIG. 7, the invention allows selection of a time measurement window 50, of Δt width, in intensity curve I(t) resulting from the measurement of the signal by the detector 22, a signal that itself results from irradiation of the sample 6 by a pulse from source 2. The means 4 (FIGS. 1A, 5A), 4′) (FIGS. 1B, 5B) therefore permit the controlling of means 22 in such a manner as to measure only part of the signal I(t). Control of the means of detection 22 produces a temporal selection in the detected signal.

Another example of application is time resolved ellipsometry. The control of an electric trigger is modified via the delay means 44 in order to be able to measure a modified index transitory effect. This is in relation to an external excitation that then triggers the measurement.

The ellipsometry device differentiates itself from known ellipsometric measurements, which are always based on light sources continuous over time.

Moreover, it differs from existing modulation techniques in that the latter exploit the reference provided by the modulator element, while an arrangement according to the invention uses a temporal reference supplied by the pulsed source or by an external element such as a second exciting source.

FIG. 4 is a diagram of the intensity I emitted by a continuous source of illumination. The modulation of the light source is carried out via a modulation system (turning polarizer or phase modulator, in which the position is fixed in time by a rotation signal 31 and the sampling comb 30 of an optical coder).

A measurement of thickness or of the index of an ultra fine layer with the use of an arrangement according to the invention uses the excitation of the surface of the sample. The thickness and/or nature of the material are deduced from a multilayer analysis and regression methods found in the various programs available commercially.

The interest of high energies results in the possibility provided by extending the spectral ranges towards UV and VUV high energies, accessible due to pulsed lamps. Interband transitions can be accessed and this at the measurement of the absorption gap of the majority of dielectrics (between 5 eV and 40 eV). At the highest energy, the ellipsometry device provides possibilities of metal measurements and also interface effects on ultra fine layers.

1-17. (canceled)

18. An ellipsometry device comprising:
a first pulsed radiating source for generating pulses;
a plurality of optical elements associated with said first pulsed radiating source for generating polarization and phase of the generated pulses, and for determining data for analysis;
a signal detector associated with said plurality of optical elements; and
a controller coupled to said first pulsed radiating source and to said signal detector for generating feedback or control pulses for said plurality of optical elements, and to said signal detector.

19. An ellipsometry device according to claim 18, wherein said first pulsed radiating source comprises at least one of an xenon arc flash and a capillary discharge tube.

20. An ellipsometry device according to claim 18, wherein said first pulsed radiating source comprises a pulsed laser.

21. An ellipsometry device according to claim 20, wherein said pulsed laser comprises a harmonics generating laser that is at least doubled or tripled in frequency.

22. An ellipsometry device according to claim 18, wherein said first pulsed radiating source comprises a white source.

23. An ellipsometry device according to claim 18, wherein said plurality of optical elements comprise a polarizer being controlled by said controller.

24. An ellipsometry device according to claim 18, wherein said plurality of optical elements comprise a compensator blade being controlled by said controller.

25. An ellipsometry device according to claim 18, wherein said plurality of optical elements comprise a photoelastic cell.

26. An ellipsometry device according to claim 18, wherein said first pulsed radiating source comprises a clock.

27. An ellipsometry device according to claim 18, wherein said controller comprises a clock, and transmits a triggering pulse to said first pulsed radiating source.

28. An ellipsometry device according to claim 27, wherein said clock operates at a frequency within a range of about 300 Hz to 500 Hz.

29. An ellipsometry device according to claim 18, further comprising a second pulsed exciting source; and a delay device for controlling delay between a triggering signal of said second pulsed radiating source and said controller.

30. An ellipsometry device comprising:
a first pulsed radiating source;
a plurality of optical elements associated with said first pulsed radiating source;
a signal detector for controlling said plurality of optical elements and for acquiring data for analysis; and
a controller coupled to said first pulsed radiating source and to said signal detector for control thereof.

31. An ellipsometry device according to claim 30, wherein said first pulsed radiating source comprises at least one of an xenon arc flash and a capillary discharge tube.

32. An ellipsometry device according to claim 30, wherein said first pulsed radiating source comprises a pulsed laser.

33. An ellipsometry device according to claim 30, wherein said pulsed laser comprises a harmonics generating laser that is at least doubled or tripled in frequency.

34. An ellipsometry device according to claim 30, wherein said first pulsed radiating source comprises a white source.

35. An ellipsometry device according to claim 30, wherein said plurality of optical elements comprises a polarizer being controlled by said controller.

36. An ellipsometry device according to claim 30, wherein said plurality of optical elements comprises a compensator blade being controlled by said controller.

37. An ellipsometry device according to claim 30, wherein said plurality of optical elements comprises a photoelastic cell.

38. An ellipsometry device according to claim 30, wherein said first pulsed radiating source comprises a clock.

39. An ellipsometry device according to claim 30, wherein said controller comprises a clock, and transmits a triggering pulse to said first pulsed radiating source.

40. An ellipsometry device according to claim 39, wherein said clock operates at a frequency within a range of about 300 Hz to 500 Hz.

41. An ellipsometry device according to claim 30, further comprising a second pulsed exciting source; and a delay device for controlling delay between a triggering signal for said second pulsed radiating source and said controller.

42. A method for ellipsometric measurement of a surface of a sample comprising:
radiating pulses from a first source to the surface of the sample;
generating polarization and phase control of the radiated pulses from the first source using a plurality of optical elements;
determining data for analysis based upon the generate pulses being reflected from the surface of the sample using the plurality of optical elements; and
generating control pulses for performing the determining.

43. A method according to claim 42, wherein radiating pulses from the first source is preceded by emission of a feedback pulse of the first source.

44. A method according to claim 42, further comprising radiating pulses from a second source to the surface of the sample before radiating pulses from the first source.

45. A method according to claim 44, wherein determining the data for analysis comprises detecting a signal at an instant that is offset in relation to an irradiation instant by the second source.

46. A method according to claim 44, wherein generating the control pulses opens a limited duration reading window.
